(19) United States
(12) Patent Application Publication
(10) Pub. No.: US 2012/0286015 A1
(43) Pub. Date: Nov. 15, 2012

(54) STAPLER

(75) Inventors: YUN-LUNG CHEN, Tu-Cheng (TW); CHUNG CHAI, Tu-Cheng (TW)

(73) Assignee: HON HAI PRECISION INDUSTRY CO., LTD., Tu-Cheng (TW)

(21) Appl. No.: 13/327,884

(22) Filed: Dec. 16, 2011

(30) Foreign Application Priority Data
May 11, 2011 (CN) 201110120996.6

(51) Int. Cl. B25C 5/02; B25C 5/11

(52) U.S. Cl. 227/128; 227/132

(57) ABSTRACT

A stapler comprises a securing member comprising a base and a securing plate perpendicular to the base, the base comprising a stapling slot; the securing plate comprising a receiving slot and a separating portion in the receiving slot; the receiving slot being divided to first and second receiving portions by the separating portion; a staple tray receives staples and comprising a pivoting shaft and a through hole aligned with the stapling slot; a pressing member comprising a protruding portion; a first resilient member attached to the pressing member, the first resilient component comprising a driving piece; wherein the pressing member is rotatably engaged with the securing plate through the pivot shaft; when the pressing member is rotated towards the securing member, the protruding portion extends through the separating portion and slidably positioned in the second receiving portion, and the driving piece drives one staple through the through hole.

### BACKGROUND

1. Technical Field

The present disclosure relates to binding devices, more particularly to a stapler for binding papers.

2. Description of Related Art

Binding papers by a stapling machine is well known. The stapling machine often includes a securing member, a receiving tray attached to the securing member, and an operating member rotatably attached to the receiving tray. When more staples are needed in the receiving tray, the operating member may be firstly rotated relative to the securing member to open the stapling machine. However, the operating member cannot be positioned in a predetermined position when released. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a stapler in accordance with an embodiment.

FIG. 2 is similar to FIG. 1, but viewed in a different aspect.

FIG. 3 is an assembled view of the stapler of FIG. 1, and a pressing member of the stapler is located in an open position.

FIG. 4 is a side view of the stapler of FIG. 3.

FIG. 5 is similar to FIG. 3, but shows the pressing member of the stapler in a closed position.

FIG. 6 is a side view of the stapler of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

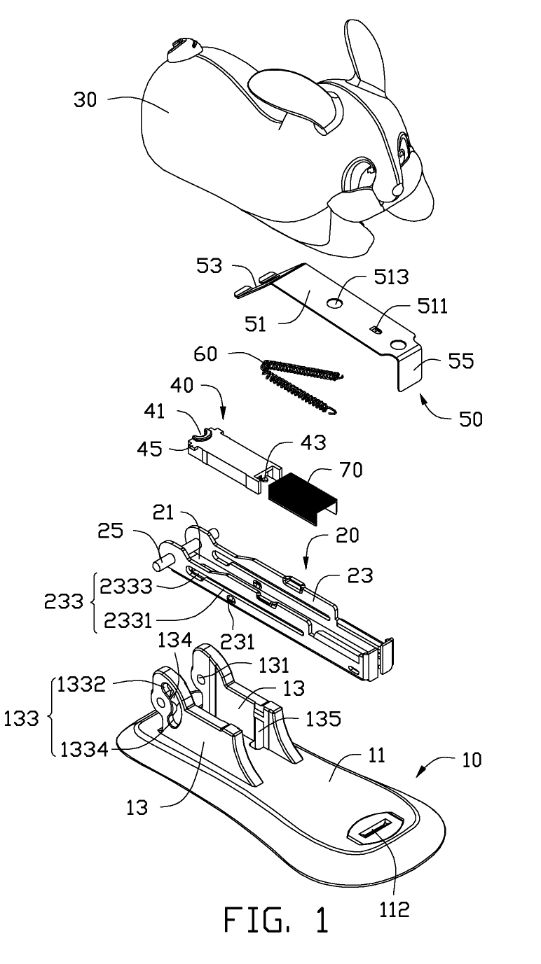

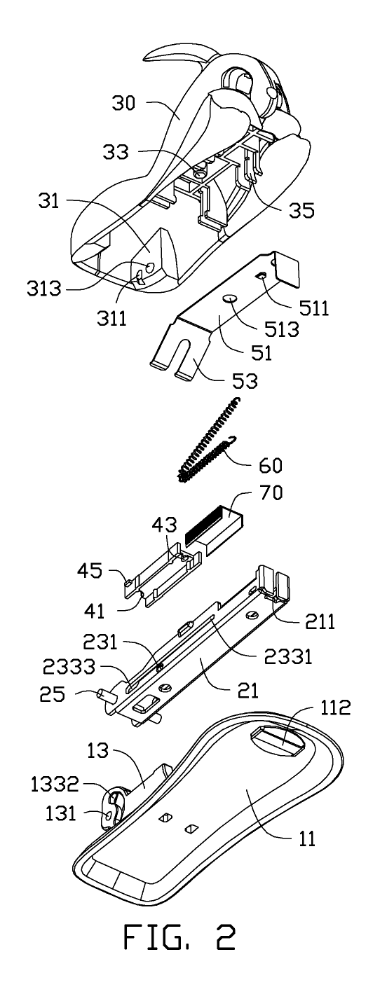

Referring to FIGS. 1 and 2, a stapler in accordance with an embodiment comprises a securing member 10, a staple tray 20, a pressing member 30, a sliding member 40, a first resilient member 50 and a second resilient member 60. The staple tray 20 is attached to the securing member 10, and the pressing member 30 is rotatably attached to the securing member 10. The sliding member 40 is slidably attached to the staple tray 20. The first resilient component 50 is attached to the pressing member 30, and the second resilient member 60 is located between the first resilient component 50 and the sliding member 40.

The securing member 10 comprises a base 11 and two securing plates 13 located on the base 11. A stapling slot 112 is defined in the base 11 and located away from the two securing plates 13. Each of the two securing plates 13 defines a pivoting hole 131 and a receiving slot 133 adjacent to the pivoting hole 131. In one embodiment, the receiving slot 133 is arcuate and located on an outer surface of each of the two securing plates 13. A separating portion 134 is defined in the receiving slot 133, to form a first receiving portion 1332 and a second receiving portion 1334. In an embodiment, the separating portion 134 has a slanted surface. A clipping slot 135 is defined in an inner surface of each of the two securing plates 13. In one embodiment, a length of the first receiving portion 1332 is less than that of the second receiving portion 1334.

The staple tray 20 comprises a bottom plate 21, two side plates 23 connected to the bottom plate 21, and a pivoting shaft 25 attached to the two side plates 23. A through hole 211 is defined in the bottom plate 21 away from the pivoting shaft 25. A clipping portion 231 and a sliding slot 233 are located on an outer surface of each of the two side plates 23. The clipping portion 231 corresponds to the clipping slot 135. The sliding slot 233 comprises a sliding portion 2331 and a positioning portion 2333 communicating with the sliding portion 2331.

Two mounting blocks 31 are located in an inner surface of the pressing member 30, and each of the two mounting blocks 31 comprises a protruding portion 313. A retaining hole 311, adjacent to the protruding portion 313, is defined in each of the two mounting blocks 31. The pressing member 30 further comprises a mounting post 33 and two limiting portions 35. In one embodiment, each of the two limiting portions 35 comprises at least two ribs arranged together.

The sliding member 40 comprises a cutout 41, a securing tab 43, and two sliding blocks 45 located on opposite sides of the cutout 41. In one embodiment, the cutout 41 is located on a first side of the sliding member 40, and the securing tab 43 is located on a second opposite side of the sliding member 40.

The first resilient member 50 comprises a main body 51, an extending piece 53 extending from a first end of the main body 51, and a driving piece 55 extending from a second end of the main body 51. The main body 51 comprises a hook 511 and a positioning hole 513 adjacent to the hook 511. In one embodiment, the first resilient member 50 is elastic, an obtuse angle is defined between the extending piece 53 and the main body 51, and the driving piece 55 is substantially perpendicular to the main body 51.

In one embodiment, the second resilient member 60 is a long spring capable of severe axial deformation.

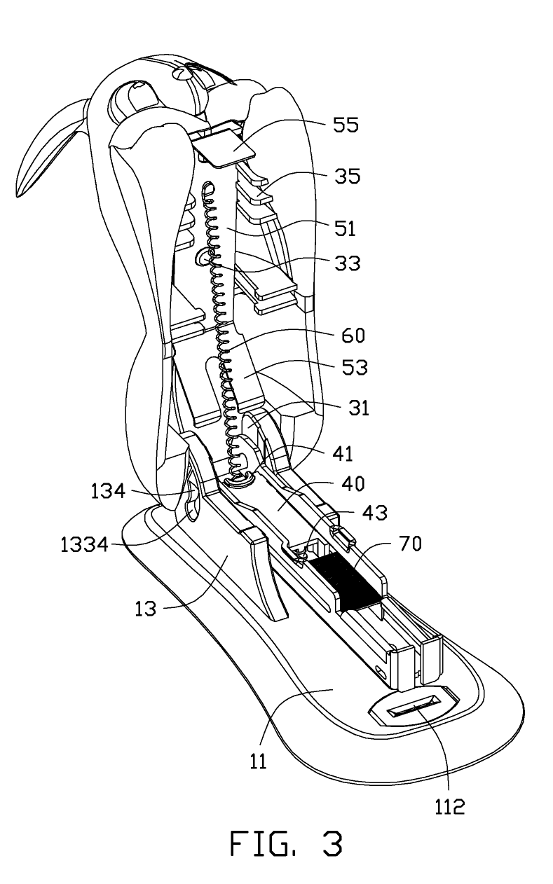

Referring to FIG. 3, in assembly, the main body 51 is located between the two limiting portions 35, and the mounting post 33 is engaged in the positioning hole 513. The first resilient member 50 is thus secured to the pressing member 30.

A first end of the second resilient member 60 is clipped to the hook 511. The second resilient member 60 is passed through the cutout 41 and extends along a bottom surface of the sliding member 40, to engage a second end of the second resilient member 60 to the securing tab 43. In one embodiment, the extending piece 53 abuts the cutout 41.

The sliding member 40 is placed between the two side plates 23, and the two sliding blocks 45 are received in the sliding slots 233. Therefore, the sliding member 40 is slidably attached to the staple tray 20.

The staple tray 20 is placed on the securing member 10. The clipping portions 231 are engaged into the clipping slots 135. The pivoting shaft 25 extends through the pivoting holes 131 and the retaining holes 311, to rotatably engage the pressing member 30 to the two securing plates 13. The protruding portions 313 are received in the receiving slots 133.

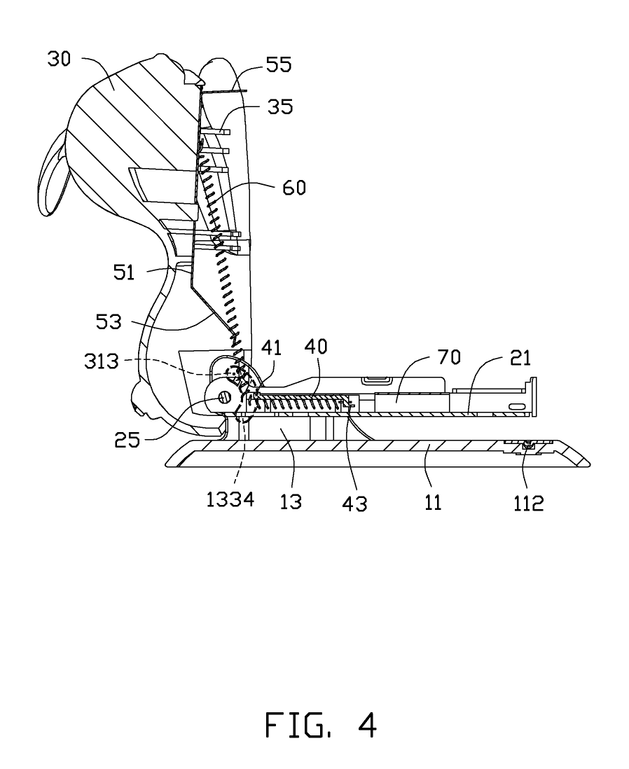

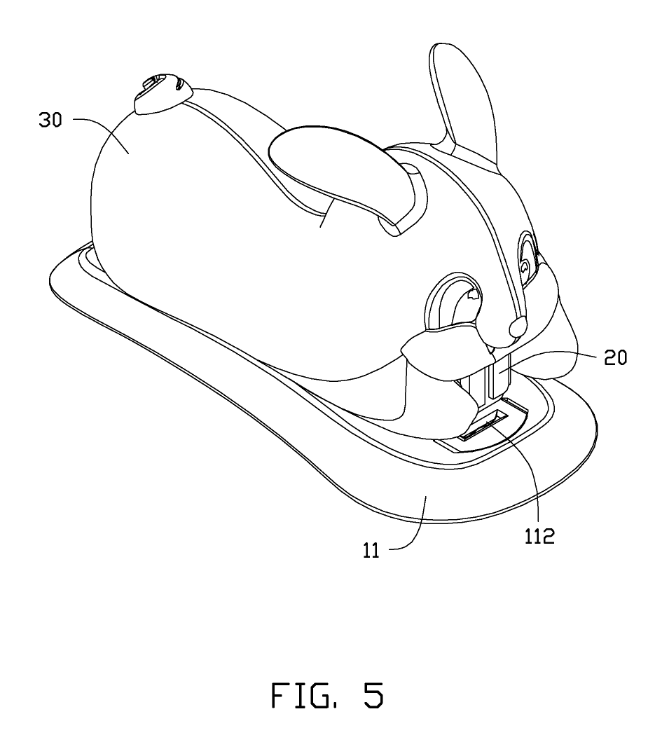

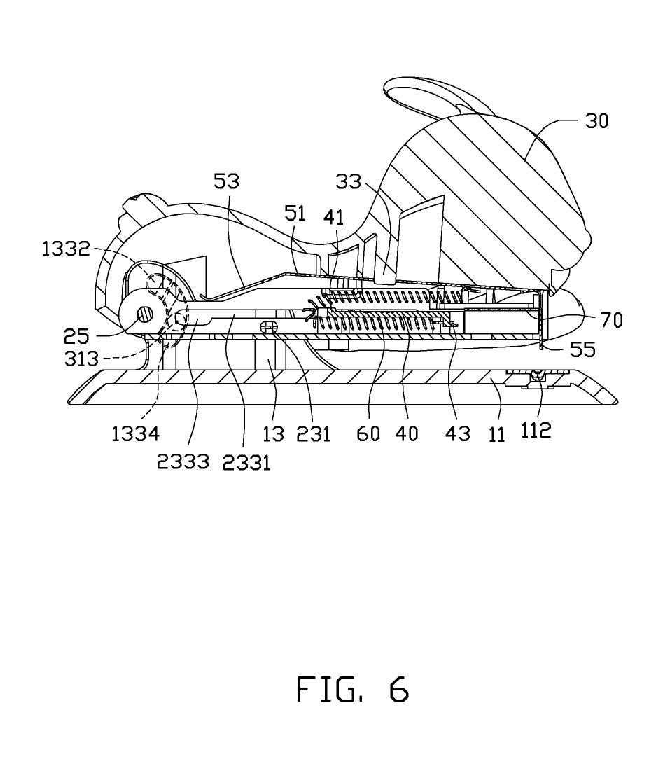

Referring to FIGS. 3-6, the pressing member 30 can be positioned in a stable open position (shown in FIGS. 3-4) or in a closed position (shown in FIGS. 5-6). When the pressing member 30 is located in the open position, the pressing member 30 is substantially perpendicular to the securing member 10, the protruding portions 313 are engaged in the first receiving portions 1332, the sliding member 40 is adjacent to the pivoting shaft 25, the two sliding blocks 45 are received in the positioning portion 2333, and the second resilient member 60 is stretched. When the pressing member 30 is located in the closed position, the pressing 30 is substantially parallel to the securing member 10, the protruding portions 313 are slidably engaged in the second receiving portions 1334, the sliding member 40 is away from the pivoting shaft 25, the two sliding blocks 45 are received in the sliding portion 2331, and the second resilient member 60 is able to contract.

In use, the pressing member 30 is rotated about the pivoting shaft 25 to the open position. A plurality of staples 70 may be placed in the staple tray 20, to abut the sliding member 40. Two or more sheets of papers may be located between the base 11 and the bottom plate 21. The pressing member 30 is rotated from the open position to the closed position. The two sliding blocks 45 are slid in the sliding portion 2331 away from the positioning portion 2333. The protruding portions 313 pass over the separating portions 134, lifted up by the slanted surface of the second receiving portions 1334. The pressing member 30 is further pressed. The protruding portions 313 slide in the second receiving portions 1334. The two sliding blocks 45 slide in the sliding portions 2331, to move the plurality of staples 70 towards the stapling slot 112, until the pressing member 30 is located in the closed position. The driving piece 55 aligns with the outermost of the plurality of staples 70. The pressing member 30 may be further pressed towards the base 11, and the first resilient member 50 is deformed, until the outermost of the plurality of staples 70 is driven by the driving piece 55 through the through hole 211 to be locked in and bind the sheets of paper together. Thus, the driving piece 55 engages in the stapling slot 112.

When the sheets of paper have been stapled together, the first resilient member 50 is released, allowing the pressing member 30 to rotate to the closed position. The second resilient member 60 drives the two sliding blocks 45 to slide in the sliding portion 2331, for moving up the remainder of the plurality of staples 70. The staple which is now the outermost of the plurality of staples 70 aligns with the driving piece 55, awaiting the next binding operation.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A stapler comprising:
a securing member comprising a base and a securing plate substantially perpendicular to the base, the base comprising a stapling slot; the securing plate comprising a receiving slot and a separating portion located in the receiving slot; the receiving slot being divided to a first receiving portion and a second receiving portion by the separating portion;
a staple tray adapted to receive a plurality of staples and comprising a pivoting shaft and a through hole aligned with the stapling slot;
a pressing member comprising a protruding portion received in the first receiving portion of the securing member;
a first resilient member attached to the pressing member, the first resilient component comprising a driving piece;
wherein the pressing member is rotatably engaged with the securing plate through the pivot shaft; when the pressing member is rotated towards the securing member, the protruding portion extends through the separating portion and is slidably positioned in the second receiving portion, and the driving piece drives one of the plurality of staples through the through hole to bind sheets of paper together.

2. The stapler of claim 1, wherein the receiving slot is arcuate.

3. The stapler of claim 1, wherein a length of the first receiving portion is less than a length of the second receiving portion.

4. The stapler of claim 1, wherein the first resilient component comprises a main body, and the driving piece is substantially perpendicular to the main body.

5. The stapler of claim 4, further comprising a sliding member slidably received in the stapler tray, wherein the sliding member is adapted to move the plurality of staples towards the through hole.

6. The stapler of claim 1, further comprises a second resilient member engaged with the sliding member between the first resilient member and the staple tray; wherein when the protruding portion is located in the first receiving portion, the second resilient member is stretched, and when the protruding portion is located in the second receiving portion, the second resilient member is contracted.

7. The stapler of claim 6, wherein the first resilient member comprises a hook; a cutout and a securing tab are defined in opposite ends of the sliding member; a first end of the second resilient member is engaged with the hook, a middle portion of the second resilient member is engaged in the cutout, and a second end of the second resilient member is engaged with the securing tab.

8. The stapler of claim 6, wherein the second resilient member is a long spring capable of severe axial deformation.

9. The stapler of claim 1, wherein the staple tray comprises a sliding slot, and the sliding member comprises a sliding block slidably received in the sliding slot.

10. The stapler of claim 1, wherein a mounting block is located an inner surface of the pressing member, the protruding portion is located on the mounting block, the mounting block further comprises a retaining hole adjacent to the protruding portion, and the pivoting shaft of the staple tray is received in the retaining hole.

11. A stapler comprising:
a securing member comprising a securing plate, the securing plate comprising a receiving slot and a separating portion located in the receiving slot; the receiving slot being divided to a first receiving portion and a second receiving portion by the separating portion; and
a pressing member rotatably attached to the securing member and comprising a protruding portion;
wherein the pressing member is rotatable relative to the securing member between an opening position and a closed position, when the pressing member is located in the opening position, the pressing member is substantially perpendicular to the securing member, and the protruding portion is positioned in the first receiving portion; when the pressing member is located in the closed position, the pressing member is substantially parallel to the securing member, and the protruding portion is slidably engaged in the second receiving portion.

12. The stapler of claim 11, wherein the receiving slot is arcuate.

13. The stapler of claim 11, wherein a length of the first receiving portion is less than a length of the second receiving portion.

14. The stapler of claim 11, further comprising a staple tray attached to the securing plate, and a sliding member slidably attached to the staple tray, the staple tray is adapted to receive a stapler, wherein when the pressing member is located in the opening position, the sliding member is located on a first side of the staple tray, when then pressing member is located in the closed position, the sliding member is located on a second side opposite to the first side of the staple tray.

15. The stapler of claim 14, wherein the staple tray comprises a pivoting shaft, the pressing member is rotatably engaged with the securing member through the pivot shaft, and the first side of the staple tray is adjacent to the pivoting shaft.

16. The stapler of claim 14, wherein the staple tray comprises a sliding slot, and the sliding member comprises a sliding block slidably received in the sliding slot.

17. The stapler of claim 14, wherein the securing member comprises a base, a stapling slot is defined in the base, and the staple tray comprising a through hole aligned with the stapling slot.

18. The stapler of claim 17, further comprising a first resilient member attached to the pressing member, the first resilient member comprises a driving piece aligned with the through hole, and the driving piece is adapted to drive a staple the through hole to bind sheets of paper together.

19. The stapler of claim 17, wherein the first resilient member comprises a main body attached to an inner surface of the pressing member, and the driving piece is substantially perpendicular to the main body.

20. The stapler of claim 17, further comprising a second resilient member located between the first resilient member and the sliding member, wherein when the pressing member is located in the opening position, the second resilient member is stretched, and when the pressing member is located in the closed position, the second resilient member is contracted.
